(19) United States
(12) Patent Application Publication
(10) Pub. No.: US 2009/0178327 A1
(43) Pub. Date: Jul. 16, 2009

(54) Fishing Rod Having A Multiple Tube Structure

(76) Inventors: Stephen J. Davis, Newtown, PA (US); Mauro Pezzato, Treviso (IT); Mauro Pinaffo, Camposampiero (IT); Roberto Gazzara, Mestre (IT); Michele Pozzobon, Fossalunga di Vedelago (IT)

Correspondence Address: FOX ROTHSCHILD, LLP;Pittsburgh, 2000 Market Street, 10th Floor, Philadelphia, PA, 19103, US

(21) Appl. No.: 12/098,693

(22) Filed: Apr. 7, 2008

(30) Foreign Application Priority Data
Jan. 10, 2008 (EP) EP 08160164.5

(51) Int. Cl. A01K 87/00; A01K 87/04

(52) U.S. Cl. 43/18.1 R; 43/18.5; 43/24; 43/18.1 HR

(57) ABSTRACT

A fishing rod system comprising multiple composite tubes bonded to one another, wherein apertures, or “ports,” are molded between the tubes to improve the stiffness, strength, aerodynamics, comfort and appearance of the fishing rod.

### RELATED APPLICATIONS

This application claims the benefit under 35 U.S.C. §119 to EPO application 08150164.5, filed Jan. 10, 2008.

### FIELD OF THE INVENTION

The present invention relates to a fishing rod and, more particularly, to a fishing rod having a composite structure and apertures or “ports” defined therein to improve the performance characteristics.

### BACKGROUND OF THE INVENTION

The performance of a fishing rod is determined by a number of factors such as weight, bending flex, bending flex distribution, torsional stiffness, and strength.

Traditional fishing rods comprise a single tubular structure with a tapered circular cross section. These rods may be solid in construction or may be constructed from a singular, hollow tube. For rods having a singular hollow tube construction, the wall thickness can vary along its length to provide specific performance needs. These rods are typically composed from a lightweight composite material.

The weight of a fishing rod can be critical feature in determining performance. Generally, the lighter the rod weight, the easier it is to swing the rod, resulting in longer casting distances. Therefore, the lightest materials and designs are used to achieve this performance goal.

The stiffness and stiffness distribution of a fishing rod are also important factors in determining the performance of a fishing rod. The bending stiffness of the fishing rod needs to match the forces created by the acceleration imposed by the casting motion to have the proper recovery such that the bait is delivered to the intended target.

There are numerous casting motions and directions. For example, a cast can vary from a vertical casting plane to a horizontal casting plane. These two casting motions will load the rod in directions perpendicular to each other. The vertical, or overhead cast, is capable of a higher acceleration and therefore higher load on the rod. The horizontal cast is a more controlled cast, used, for example, for casting under tree limbs where motion is limited, and therefore would benefit from a more flexible rod.

A fishing rod is, in fact, subjected to a multitude of stress conditions. There are mainly bending loads from casting or the pull of a fish. There are also impact loads and vibrational loads. In addition, there are high stress concentrations where the reel connects to the rod. The clamping mechanism to attach the reel to the rod can impose a large circumferential compressive stress on the rod in this area. Furthermore, the line guides can exert forces on the rod in these locations. For this reason, the wall thickness of the rod is the greatest in these areas. As a result, the rod can be heavier than desired.

As mentioned above, the evolution of the fishing rod technology over the past twenty years has focused on improving weight, stiffness, and strength. However, there has not yet been a fishing rod that has meaningfully improved casting distance, or provided anisotropic behavior in different directions.

The most popular high performance material for modern fishing rod design is carbon fiber reinforced epoxy resin (CFE) because it has the highest strength and stiffness to weight ratio of any realistically affordable material. As a result, CFE can produce a very light weight fishing rod with excellent strength. Because of the anisotropic properties of composite materials, the rods constructed therefrom can be tailored to provide different stiffnesses in different directions and locations along the length of the rod.

However, there are limitations based on the traditional design of the single tube fishing rod, and further limitations on the carbon fiber based materials used for fishing rod structures when considering strength requirements. A fishing rod made from carbon fiber composite can be susceptible to catastrophic failure resulting from excessive compressive forces, which can cause buckling of the thin walled tube.

Traditional fishing rods are manufactured with relatively complex and expensive processes. The most common method of producing a traditional composite fishing rod is to start with a raw material in sheet form known as “prepreg”, which is a thermoset resin, such as epoxy, which is impregnated with reinforcing fibers. The resin is in a “B Stage” liquid form which can be readily cured with the application of heat and pressure. The fibers can be woven like a fabric, or unidirectional, and are of the variety of high performance reinforcement fibers such as carbon, aramid, fiberglass, boron, etc. The prepreg commonly comes in a continuous roll, or can be drum wound which produces shorter sheet length segments. The prepreg is cut at various angles to achieve the correct fiber orientation, and these strips are typically overlapped and positioned in a “lay-up” which allows them to be rolled over a mandrel to form a preform. To pressurize and consolidate the prepreg plies, external pressure must be applied. This is commonly done by wrapping a polymer “shrink tape” around the exterior of the preform which will apply pressure upon the application of heat in a curing oven. The mandrel determines the internal geometry of the fishing rod. The thickness of the consolidated laminate plies determines the external geometry of the rod, the cross section of which is generally circular because of the rolling process.

There have been numerous patents describing this manufacturing process, such as U.S. Pat. No. 2,749,643 (Scott), U.S. Pat. No. 3,421,347 (Hubbard) and U.S. Pat. No. 4,061,806 (Lindlerm, et. al). Other notable patents producing a single hollow tube are U.S. Pat. No. 4,178,713 (Higuchi), U.S. Pat. No. 4,653,216 (Inoue), U.S. Pat. No. 6,454,691 (Hsu), U.S. Pat. No. 6,601,334 (Ono, et. al) and U.S. Pat. No. 7,043,868 (Ahn). Of particular note is U.S. patent application Ser. No. 11/971,005 by Davis, et. al., the inventors herein, that describes a fishing rod having a single primary tube with ports that extend through aligned holes on opposite sides of the hollow tube.

Other notable designs involve the line traveling inside the rod, some of which involve an internal structure to facilitate this feature. Examples are U.S. Pat. No. 5,564,214 (Tsurufuji), U.S. Pat. Nos. 6,048,425 and 6,543,178 (Sunaga, et. al), U.S. Pat. No. 6,243,981 (Komura, et. al) and U.S. Pat. Nos. 6,266,913, 6,334,272, and 6,351,909 (Akiba, et. al).

Thus, there exists a continuing need for an improved fishing rod that has the combined features of improved aerodynamics, light weight, improved bending stiffness, and improved strength. The objective of the present invention is to provided a fishing rod, which overcomes the identified drawbacks of the prior art.

### SUMMARY OF THE INVENTION

The present invention provides a fishing rod representing an improvement over the current state of the art fishing rods. The rod of the present invention utilizes a multiple tube structure, in which multiple tubes are fused together along portions of their lengths, so as to form one or more internal walls. This multi-tube structure also provides for the disposition of apertures or ports at various locations which can vary longitudinally and axially on the rod.

To form the ports, the tubes are separated from one another at selected locations to form apertures that act as double opposing arches, providing improved aerodynamics, light weight, improved bending stiffness, and improved strength. The number of ports and their locations can be varied to provide different performance characteristics, and the ports also provide an aerodynamic benefit during the casting of the rod.

The fishing rod, according to the invention, may be designed to have specific stiffness zones at various orientations and locations along the length of the rod. Thus, it is possible to remarkably improve the torsional stiffness of the rod and achieve a superior strength and fatigue resistance, an improved shock absorption and improved vibration damping characteristics.

The fishing rod, according to the invention, has also a unique look and improved aesthetics and may be easily and efficiently manufactured, at low cost with regard to both materials and labor.

For a better understanding of the invention and its advantages, reference should be made to the accompanying drawings and detailed description.

### DESCRIPTION OF THE DRAWINGS

FIG. 1 is an isometric view of a fishing rod constructed in accordance with one embodiment of the present invention.

FIG. 1A is a cross section of the fishing rod of FIG. 1 along line 1A-1A.

FIG. 1B is a cross section of the fishing rod of FIG. 1 along line 1B-1B.

FIG. 1C is an isometric cut away view of a portion of the fishing rod shown in FIG. 1.

FIG. 2 is a side view of a fishing rod constructed in accordance with an embodiment of the present invention.

FIG. 2A is a longitudinal sectional view of a portion of the fishing rod taken along line 2A-2A in FIG. 2.

FIG. 3 is an isometric view of a fishing rod constructed in accordance with an alternate embodiment of the present invention.

FIG. 3A is a cross section of the fishing rod of FIG. 3 along line 3A-3A.

FIG. 3B is a cross section of the fishing rod of FIG. 3 along line 3B-3B.

FIG. 3C is an isometric cutaway view of a portion of the fishing rod shown in FIG. 3.

FIG. 4 shows an isometric cutaway view of an alternative embodiment of the invention.

FIG. 4A is a cross section of the embodiment of FIG. 4 along line 4A-4A.

FIGS. 5A-5D show various possible shapes of ports.

FIGS. 6 and 7 are perspective views illustrating a process for forming yet another embodiment of the rod of the present invention in which a portion of the rod has a multiple tube construction and a different portion of the rod has a single tube construction.

FIG. 8 is an isometric view of an alternative design of the handle area of the fishing rod, showing a possible method of mounting a reel.

### DETAILED DESCRIPTION

As described below, the fishing rod of the present invention is formed of two or more uncured tubes which are molded together to form a common, internal wall (or walls, in the case of more than two tubes) along their facing surfaces. This internal wall improves the bending strength of the fishing rod by acting as a brace to resist the compressive loads which can buckle the structure, causing catastrophic failure.

At selected locations, the facing surfaces of the tubes are kept apart during molding, to form openings. On either side of the openings, the tubes are joined together to form the internal wall. The openings so formed are referred to herein as “ports” and are apertures which extend through the rod. These ports are formed without drilling any holes or severing any reinforcement fibers, thus improving the strength of the rod.

The resulting structure is found to have superior performance characteristics for several reasons. First, the ports are in the shape of double opposing arches which allows the structure to deflect, which deforms the ports, and return with more resiliency. The ports also allow greater bending flexibility than can be achieved in a traditional single tube design. Second, the ports improve the aerodynamic performance of the rod, allowing air to pass through the ports, resulting in faster casting speeds and greater casting distances. Third, the internal wall between the hollow tubes adds strength to resist compressive buckling loads.

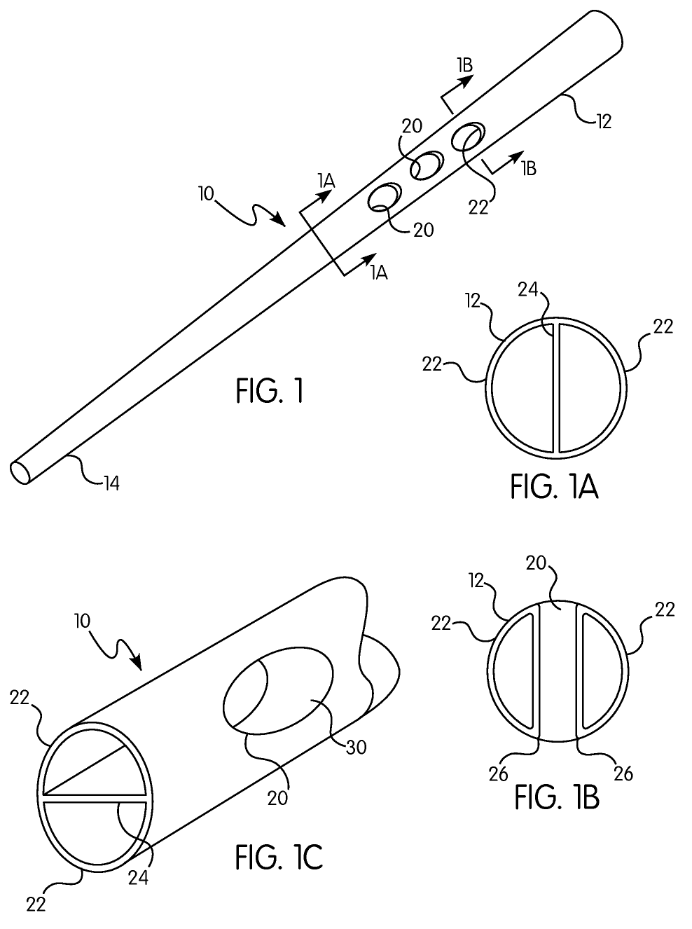

With reference to FIG. 1 of the drawings, the present invention is a composite fishing rod 10. The rod features ports 20 of various geometric shapes defined in the rod for improving the flexibility, strength and other playing characteristics of the rod. The rod comprises a handle end 12, about which a grip and reel are normally attached, and a tip end 14, to which a loop shaped line guide is typically attached. Rod 10 is preferably fabricated of multiple layers of aligned carbon filaments held together with an epoxy binder (i.e., a so-called “graphite” material). The fibers in the various plies are preferably parallel to one another, but the various plies preferably have varying fiber orientations.

Rod 10 has a long, generally hollow configuration that preferably tapers from handle end 12 to tip end 14.

A plurality of ports 20 are formed in rod 10. Ports 20 extend between opposed walls of the rod, as described further below. Each port 20 is preferably oval in shape, with the long axis of the oval in alignment with the longitudinal axis of rod 10 and the longitudinal axes of ports 20 oriented perpendicular to the longitudinal axis of rod 10. Ports 20 may have any radial orientation with respect to the longitudinal axis of rod 10, but preferably are oriented such as to provide the greatest aerodynamic benefit during casting.

Each port 20 includes a peripheral wall 21 that extends through rod 10. Peripheral wall 21 is formed from the facing surfaces of tubes 22 which were not allowed to fuse together during the molding process of rod 10.

Ports 20 are preferably ovoid or elliptical in shape, forming double opposing arches which allow the structure to deflect, which deforms the ports, and return with more resiliency. Ports 20 therefore allow greater bending flexibility and strength than would traditionally be achieved in a single tube design, because internal wall 24 between the tubes and the peripheral wall 21 of each port 20 help prevent buckling failures of the thin walled tubular rod. If the axes of the ports are in line with the casting direction, they can provide an aerodynamic advantage, allowing air to pass through the rod, resulting in faster swing speeds and further casts. Finally, the ports create a unique appearance to the fishing rod.

The cross sectional view of FIG. 1A shows the two hollow tubes 22 which form the structure of the rod in this embodiment. Hollow tubes 22 are joined together to form an internal wall 24. Preferably, the plane of internal wall 24 will include the longitudinal axis of rod 10, but internal wall 24 may also be offset. Both hollow tubes 22 should be about the same size and, when molded, form a “D” shape.

FIG. 1B shows that, at the locations of ports 20, hollow tubes 22 are separated from one another to form peripheral wall 21 defining ports 20. It is advisable to have a radiused (i.e., rounded) edge 26 leading into the port so to reduce the stress concentration and to facilitate the molding process.

FIG. 1C is an isometric view of rod 10 isolated to one port, which shows hollow tubes 22 and internal wall 24. Also shown is the port 20 formed by curved peripheral wall 21 which may have the shape of a portion of a cylinder. In this particular example, the axis of port 20 is orthogonal to the longitudinal axis of rod 10.

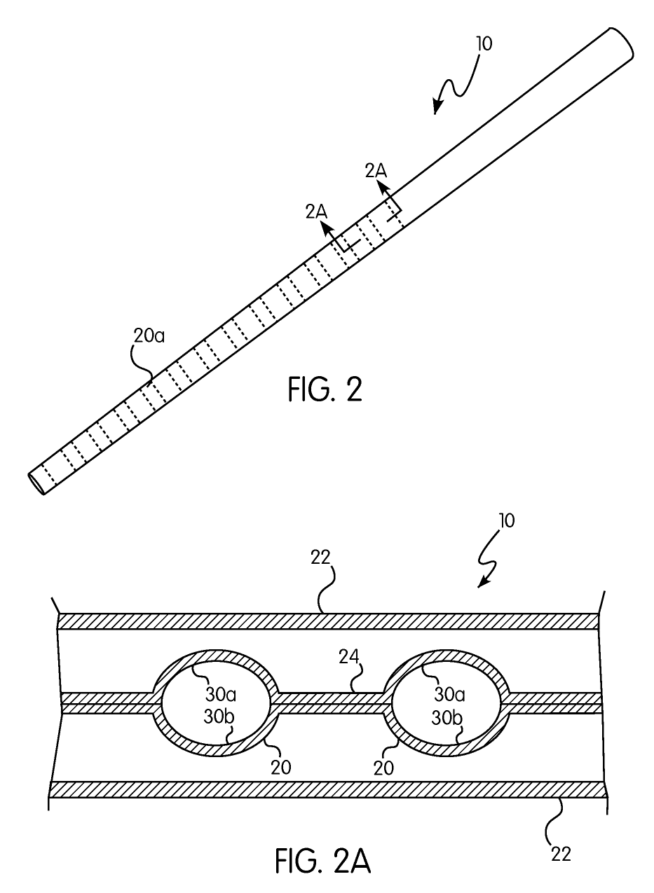

FIG. 2A is a longitudinal section view taken along line 2A-2A in FIG. 2. It shows that, at locations other than where ports 20 are located, hollow tubes 22 are positioned side-by-side and are fused together along their facing sides to form common internal wall 24 that extends across the diameter of rod 10, (i.e., the wall bisects the rod interior). At selected locations, where ports 20 are to be formed, the facing surfaces 21 of tubes 22 are separated during molding to form apertures 20 in the shape of double opposing arches, which act as geometric supports to allow deformation and return. In addition, internal wall 24 provides structural reinforcement to resist deformations and buckling failures.

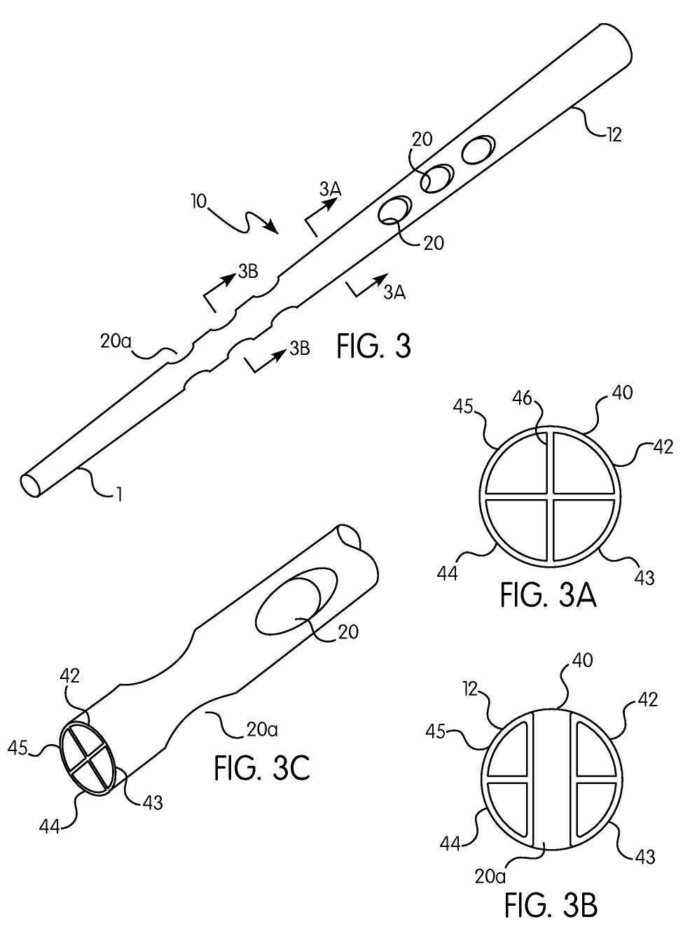

FIG. 3 shows an alternative embodiment in which ports 20 and 20a are formed in rod 10, such that the axes of ports 20a are orthogonal to the axes of ports 20. Such a design requires that rod 10 be constructed of four tubes, 42, 43, 44 and 45, shown in FIGS. 3A-3C. This configuration creates internal wall 46 in the shape of an “X” or cross.

In this particular example, ports 20a, near tip end 14 of rod 10, are in line with the direction of casting, to provide greater in flexibility in this area. Ports 20 near grip end 12 of rod 10 are oriented perpendicular to the direction of casting, which will provide a traditional stiffness with increased strength. Therefore a fishing rod with this type of design would be considered to have a flexible tip region and a more traditional handle region. It is also possible to have the opposite configuration, or any other configuration desired.

The FIG. 3B cross section, taken along line 3B-3B of FIG. 3, is in the region of port 20a, which is oriented parallel to the casting direction. In this example hollow tubes 42 and 43 have remained together and hollow tubes 44 and 45 have remained together, forming partial internal wall 46. Hollow tubes 42 and 43 are separated from hollow tubes 45 and 44 respectively during molding to create port 20a. To create port 20, tubes 45 and 42 would be kept separate from tubes 44 and 43 respectively (not shown in cross section).

FIG. 3C is an isometric view of a cutaway portion of rod 10 of FIG. 3 showing ports 20a oriented parallel to the direction of casting, and ports 20 oriented perpendicular to the direction of casting.

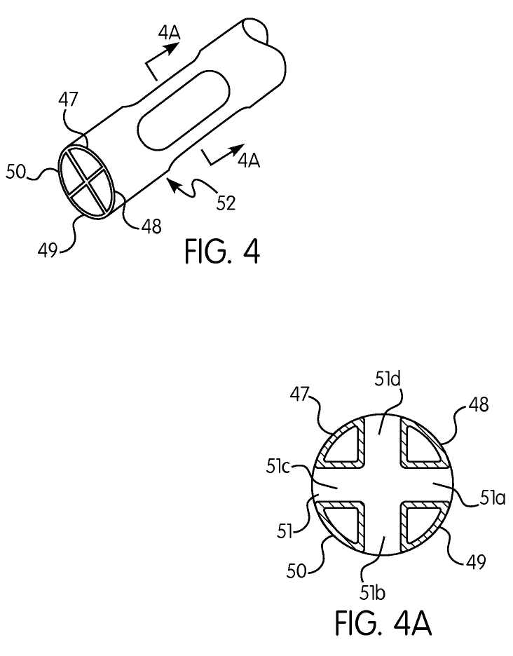

FIG. 4 is an isometric cutaway view showing an alternative embodiment in which ports having orthogonal axes are co-located at the same longitudinal location along rod 10. This creates port 51 having four openings 51a-51d. In this example, hollow tubes 47, 48, 49, and 50 are all separated in the same location to form the four openings therebetween.

FIG. 4A is a cross-sectional view of the tube structure 52 in FIG. 4 taken along the lines 4A-4A showing the openings 51a-d. This particular embodiment would provide more flexibility and resiliency for both in plane and out of plane conditions at the same location.

In a multiple tube design, there can be any number of ports and orientations of ports, depending on the number of hollow tubes used and how many are separated to form these ports. For example, with a 3 tube design, not shown in any figures, the axis of the port would not necessarily have to pass through the center of the rod. In such an embodiment a “Y” shaped internal wall would be formed and a port having three openings offset by 120 degrees with respect to each other would be formed.

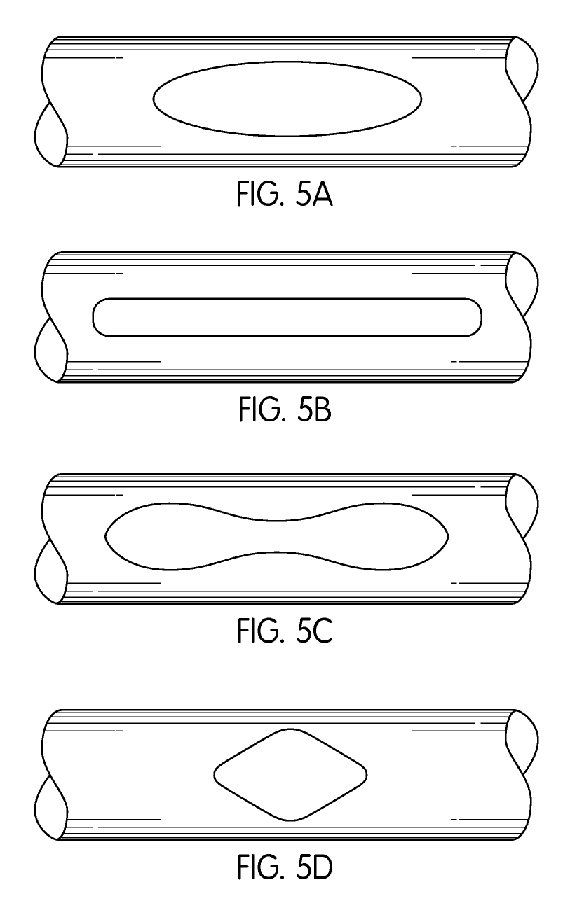

FIGS. 5A-5D illustrate some examples of the variety of possible shapes for the ports. Depending on the performance required of the structure at a particular location, more decorative port shapes can be used. The invention is not intended to be limited to these port designs. They are shown here only as examples of possible port configurations.

The process of molding with composite materials facilitates the use of multiple tubes in a structure. The most common method of producing a traditional composite fishing rod was described in the background section.

The present invention, however, requires a different molding technique because the use of multiple tubes and the formation of ports requires internal pressure to consolidate the prepreg plies. For one thing, when molding the fishing rod using two prepreg tubes, each tube should be approximately half the size of the single tube, for four tubes, one forth the size, etc. A polymer bladder is inserted into the middle of each prepreg tube and is inflated and held at a predetermined pressure to generate internal pressure to consolidate the plies upon the application of heat.

The mold packing process consists of taking each prepreg tube and internal bladder and positioning them into a mold cavity. An air fitting is then attached to the bladder. The process is repeated for each tube, depending on how many are used. Care should be taken for the position of each tube so that the internal wall formed between the tubes is oriented properly. To form the ports, mold pins can be inserted between the tubes to keep the facing walls of the tubes separated at the desired locations of the ports during pressurization. The pins are secured into portions of the mold and are easily removed after the rod has cured.

The mold is pressed closed in a heated platen press and air pressure for each tube is applied simultaneously to retain the size and position of each tube and the common wall in between. Preferably, each tube should be kept at the same pressure. Simultaneously, the facing walls of the tubes will form around the pins to form the ports. As the temperature rises in the mold, the viscosity of the epoxy resin decreases and the tubes expand, pressing against each other until expansion is complete and the epoxy resin is cross linked and cured. The mold is then opened, the pins removed, and the part is removed from the mold.

The internal wall of the molded tubular part adds significantly to improving the structural properties of the tubular part. For example, during bending or torsional deflection, the shape of the fishing rod is better maintained, eliminating the tendency to buckle the cross section.

The orientation of the wall can be positioned to take advantage of the anisotropy it offers. If more bending flexibility is desired, the wall can be positioned along the neutral axis of bending. If greater stiffness is needed, then the wall can be positioned like an “I Beam” at 90 degrees to the neutral axis to improve the bending stiffness.

Molding the tubular parts using multiple tubes allows greater design options. Separating the hollow tubes at selected axial locations along the rod to mold large oval shaped openings between the tubes, allows the characteristics of the fishing rod to be varied as desired.

Molding in of apertures, or ports, at selected locations results in a double opposing arch construction. The “double arch effect” of the ports, which are oval in shape, creating two opposing arches, allows the tubular part to deflect, while retaining the cross sectional shape of the tube because of the three dimensional wall structure provided by the port. For example, a ported double tube structure has a combination of exterior walls which are continuous and form the majority of the structure, and ported walls, which are oriented at an angle to the exterior walls, which provide strut like reinforcement to the tubular structure. The cylindrical walls of the ports prevent the cross section of the tube from collapsing, which significantly improves the strength of the structure.

The stiffness and resiliency of the ported double tube structure can be adjusted to be greater or less than a standard single hollow tube. This is because of the option of orienting the internal wall between the tubes as well as the size, shape, angle and location of the ports. The ports can be stiff if desired, or resilient, allowing more deflection and recovery, or can be designed using different materials or a lay-up of different fiber angles to produce the desired performance characteristics of the structure.

In another embodiment of the invention, a single composite tube may be combined with the multiple tube design. In this example, the single composite tube can be a portion of the fishing rod made in the traditional method previously mentioned, and co-molded with the multiple tubes to produce a lower cost alternative to a 100% multiple tube construction rod.

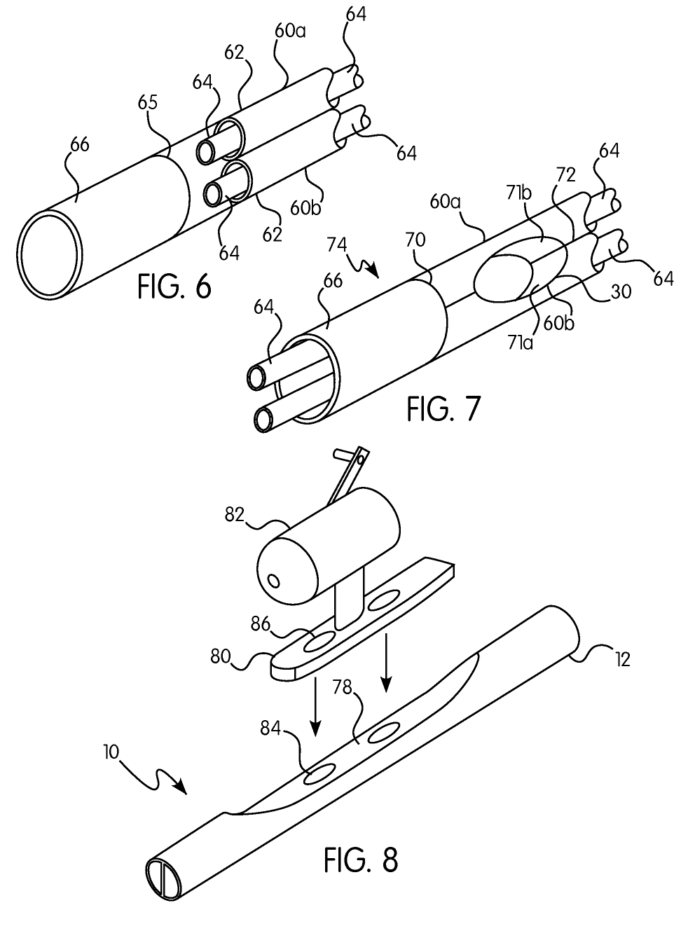

Referring to FIGS. 6-7, to make this construction, forward ends 62 of a pair of prepreg tubes 60a, 60b, each having an inflatable bladder 64, are inserted into one end 65 of a traditional composite tube 66. The unit is placed inside a mold having the same shape of composite tube 66, at least at juncture 70 of prepreg tubes 60a, 60b and composite tube 66. A pin or mold member (not shown) is placed between prepreg tubes 60a, 60b where port 30 is to be formed. The mold is then closed and heated, as bladders 64 are inflated, so that the prepreg tubes assume the shape of the mold, the mold member keeps facing walls 71a, 71b apart so as to form port 30. As shown, tubes 60a and 60b will form common wall 72. After the prepreg tubes have cured, frame member 74 is removed from the mold, and the mold member or pin is removed, leaving port 30. In this embodiment, the seam between graphite portions 60a, 60b of frame member 74 and composite tube portion 66 should be flush. Tube portion 66 may also be made of metal, plastic, wood, or any other common material.

There is a very distinguished appearance to a fishing rod made according to the invention. The ports are very visible, and give the tubular part a very light weight look, which is important in rod marketing. The ports can also be painted a different color, to further enhance the signature look of the technology.

There are unlimited combinations of options when considering a double opposing arch structure. The ports can vary by shape, size, location, orientation and quantity. The ports can be used to enhance stiffness, resilience, strength, comfort and aesthetics. For example in a low stress region, the size of the port can be very large to maximize its effect and appearance. If more deflection or resilience is desired, the shape of the aperture can be very long and narrow to allow more flexibility. The ports may also use designer shapes to give the product a stronger appeal. The ports may also have axes that are not orthogonal to the longitudinal axis of the rod, for example, a port may be defined in the rod to allow a fishing line to pass therethrough from one side of the rod to the other.

If more vibration damping is desired, the ports can be oriented and shaped at a particular angle, and constructed using fibers such as aramid or liquid crystal polymer. As the port deforms as a result of rod deflection, its return to shape can be controlled with these viscoelastic materials which will increase vibration damping. Another way to increase vibration damping is to insert an elastomeric material inside the port.

Although only rods having circular cross sectional shapes are shown herein, the invention also allows for other cross sectional shapes to be molded in the rod, because the rod is formed by internal pressurization inside a mold with a cavity that defines the external shape of the rod. For example, the rod may have an oval or polygonal shaped cross section, or may be irregularly shaped, as in a teardrop shape.

In addition, the rod may have ridges molded in the surface thereof. The rod can be made stiffer by adding one or more ridges on the external surface of the rod. For example, the placement of the ports in the rod will tend to decrease the rod stiffness in the areas defining the ports. The stiffness in these areas can be increased by defining ridges in the vicinity of the ports. Such ridges can be longitudinally or circumferentially disposed, and can be of limited length or can run the entire length of the rod.

Additionally, the cross-sectional shape of the rod can also affect stiffness, particularly when the cross-sectional shape of the rod defines comers, such as with a polygonal or teardrop cross sectional shape. Note that if uniform stiffness is not desired, ridges may be added to increase the stiffness in some areas, while leaving other areas unaltered. Absent any ridges or corners, the stiffness of the rod will be defined by the manner and angle at which the prepreg strips were laid out to form the basic hollow rod, as previously discussed. The invention is therefore meant to encompass rods having any cross sectional shape.

Another advantage of the invention could be to facilitate the attachment of the reel. Having one or more ports at the handle portion of the rod that where the reel will attach provides a mechanical means of attachment to the reel to better secure it to the rod.

FIG. 8 shows such an example of handle end 12 of rod 10 molded with two tubes 22 that form internal wall 24 therebetween. Recessed area 78 is formed in the rod by the shape of the mold to accommodate foot 80 of reel 82. Ports 84 are formed in the recessed area 78 that line up with holes 86 in foot 80 of reel 82. A fastening means attaches foot 80 to the recessed area 78 going through holes 86 and ports 84.

One advantage of recessed area 78 is that it reduces the distance of the axis of the reel to the center of the rod. This facilitates releasing the line through the guides for increased casting distances as well as enhanced feel.

Another option is for the fishing line to travel from the reel through a port in the rod to the opposite side of the rod. This would provide an advantage for reel designs that operate on the top side of the rod, yet position the line and guides on the bottom side of the rod, which is a preferred location because it is more stable. This is not possible with conventional rod designs.

With respect to the above description then, it is to be realized that the optimum dimensional relationships for the parts of the invention, to include variations in size, materials, shape, form, function and manner of operation, assembly and use, may vary without departing from the scope of the invention. Therefore, the foregoing is considered as illustrative only of the principles of the invention. Further, it is not desired to limit the invention to the exact construction and operation shown and described, and accordingly, all suitable modifications and equivalents may be resorted to, falling within the scope of the invention.

We claim:

1. A fishing rod comprising:
a. two or more hollow tubes having facing surfaces, wherein said facing surfaces are fused together along portions of their lengths to form an internal reinforcing wall;
b. wherein the surfaces of said two or more tubes not facing the surface of another of said tubes forms a portion of the external surface of said fishing rod; and
c. one or more ports extending through said fishing rod, said ports being formed by separating said facing surfaces of said two or more tubes in one or more locations.

2. The fishing rod of claim 1 wherein the axes of said one or more ports are orthogonal to the longitudinal axis of said fishing rod.

3. The fishing rod of claim 2 wherein one or more of said ports are oriented in a first radial direction relative to said longitudinal axis of said rod, and further wherein one or more of said ports are oriented in a second radial direction relative to said longitudinal axis of said rod.

4. The fishing rod of claim 1 wherein said tubes are composed of a composite material.

5. The fishing rod of claim 4 wherein said composite material is a fiber reinforced resin.

6. The fishing rod of claim 5 wherein said fibers are selected from a group consisting of carbon, fiberglass, aramid and boron.

7. The fishing rod of claim 5 wherein said resin is selected from a group consisting of epoxy, polyester, vinyl ester, nylon, polyamide resins, ABS and PBT.

8. The fishing rod of claim 1 comprising three hollow tubes, wherein said internal reinforcing wall is Y-shaped.

9. The fishing rod of claim 8 wherein one or more ports having openings located 120 degrees apart extend through said fishing rod

10. The fishing rod of claim 1 comprising four hollow tubes, wherein said internal reinforcing wall is X-shaped.

11. The fishing rod of claim 10 defining a plurality of ports therein, wherein one or more ports have axes oriented in a first direction and one or more ports have axes oriented in a second direction orthogonal to said first direction.

12. The fishing rod of claim 11 wherein one of said ports having an axis oriented in a first direction and one of said ports having an axis oriented in a second direction are co-located along said fishing rod, forming a port having four openings.

13. The fishing rod of claim 11 wherein one or more of said ports having an axis oriented in a first direction and one or more of said ports having an axis oriented in a second direction are disposed at different locations along said fishing rod.

14. The fishing rod of claim 1 wherein said ports are circular, elliptical or oval in shape, forming double, opposing arches.

15. The fishing rod of claim 1 having a cross sectional shape other than circular along at least a portion of its length.

16. The fishing rod of claim 15 wherein said rod has a cross section shape along at least a portion of its length selected from a group comprising ovoid, polygonal and teardrop shapes.

17. The fishing rod of claim 1 wherein the external dimensions of said rod vary along the length of said rod.

18. The fishing rod of claim 1 wherein said external surface of said rod defines one or more ridges therein.

19. The fishing rod of claim 18 wherein said ridges are longitudinally or circumferentially disposed on the surface of said rod.

20. The fishing rod of claim 1 wherein said external surface of said rod defines an area shaped to facilitate the mounting of a reel thereon.

21. The fishing rod of claim 20 wherein the mounting of a reel on said shaped area moves the longitudinal axis of said reel closer to the longitudinal axis of said rod.

22. The fishing rod of claim 20 wherein said rod defines one or more ports in said shaped area to facilitate the attachment of said reel to said rod.

23. The fishing rod of claim 1 defining one or more ports therein disposed to be used as line guides.

24. The fishing rod of claim 1 defining one or more ports therein disposed such that a fishing line can pass therethrough from one side of said rod to the other.

25. The fishing rod of claim 1 further comprising a portion constructed from a single tube, said single tube portion being fused to said two or more hollow tubes.

26. The fishing rod of claim 25 wherein said single tube portion is composed of a composite material and is co-cured with said two or more hollow tubes.

27. The fishing rod of claim 1 further comprising a pre-formed portion fused to said two or more hollow tubes.

28. The fishing rod of claim 27 wherein said pre-formed portion is composed of a material other than a composite material.

29. The fishing rod of claim 1 wherein said one or more ports are filled with a visco-elastic material.
